(19) United States
(12) Patent Application Publication
(10) Pub. No.: US 2025/0267038 A1
(43) Pub. Date: Aug. 21, 2025

(54) IN-VEHICLE DEVICE, PROGRAM, AND INFORMATION PROCESSING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Koji YASUDA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/859,349

(22) PCT Filed: Apr. 10, 2023
(86) PCT No.: PCT/JP2023/014479

§ 371 Date: Oct. 23, 2024

(30) Foreign Application Priority Data
Apr. 27, 2022 (JP) 2022-073430

(51) Int. Cl. H04L 12/46; H04L 12/28

(52) U.S. Cl. CPC H04L 12/46; H04L 12/28

(57) ABSTRACT

An in-vehicle device is to be connected to an in-vehicle network installed in a vehicle and includes: a first processing unit; a second processing unit connected to the first processing unit; and a physical layer communication unit connected to the second processing unit. The first processing unit includes a first upper layer communication unit corresponding to a layer that is higher than the physical layer communication unit, the second processing unit includes a second upper layer communication unit corresponding to a layer that is higher than the physical layer communication unit, the first processing unit and the second processing unit are connected via the first upper layer communication unit, and the second processing unit and the physical layer communication unit are connected via the second upper layer communication unit.

### CROSS-REFERENCE TO RELATED APPLICATIONS

This application is the U.S. national stage of PCT/JP2023/014479 filed on Apr. 10, 2023, which claims priority of Japanese Patent Application No. JP 2022-073430 filed on Apr. 27, 2022, the contents of which are incorporated herein.

### TECHNICAL FIELD

The present disclosure relates to an in-vehicle device, a program, and an information processing method.

### BACKGROUND

A vehicle is equipped with a body ECU (Electronic Control Unit), which is an in-vehicle ECU that is in overall control of vehicle body-related devices, such as a wiper driving device, internal and external lighting devices of the vehicle, door locking devices, and power windows (see, for example, JP 2017-224926A). The wiper driving device according to JP 2017-224926A includes an in-vehicle ECU (body ECU) and is driven by a control program that is applied to the in-vehicle ECU.

With the in-vehicle ECU according to JP 2017-224926A, when a control unit provided in the in-vehicle ECU executes a plurality of applications, no consideration is given to efficiently performing communication-related processing that is executed in response to the operation of such applications.

It is an object of the present disclosure to provide an in-vehicle device and the like that can efficiently perform processing related to communication.

### SUMMARY

A in-vehicle device according to an aspect of the present disclosure is to be connected to an in-vehicle network installed in a vehicle and includes: a first processing unit; a second processing unit connected to the first processing unit; and a physical layer communication unit connected to the second processing unit, wherein the first processing unit includes a first upper layer communication unit corresponding to a layer that is higher than the physical layer communication unit, the second processing unit includes a second upper layer communication unit corresponding to a layer that is higher than the physical layer communication unit, the first processing unit and the second processing unit are connected via the first upper layer communication unit, and the second processing unit and the physical layer communication unit are connected via the second upper layer communication unit.

### Advantageous Effects of Invention

According to an aspect of the present disclosure, it is possible to provide an in-vehicle device and the like that can efficiently perform processing related to communication.

### BRIEF DESCRIPTION OF DRAWINGS

FIG. 1 is a schematic diagram depicting an example system configuration of an in-vehicle system according to a first embodiment.

FIG. 2 is a block diagram depicting an internal configuration of an in-vehicle device included in the in-vehicle system.

FIG. 3 is a diagram for explaining one example of a communication control table.

FIG. 4 is a flowchart indicating the processing of a first processing unit and a second processing unit provided in an in-vehicle device.

### DETAILED DESCRIPTION OF PREFERRED EMBODIMENTS

Several embodiments of the present disclosure will first be listed and described in outline. Note that the embodiments described below can be freely combined with each other, at least in part.

An in-vehicle device according to an aspect of the present disclosure is to be connected to an in-vehicle network installed in a vehicle and includes: a first processing unit; a second processing unit connected to the first processing unit; and a physical layer communication unit connected to the second processing unit, wherein the first processing unit includes a first upper layer communication unit corresponding to a layer that is higher than the physical layer communication unit, the second processing unit includes a second upper layer communication unit corresponding to a layer that is higher than the physical layer communication unit, the first processing unit and the second processing unit are connected via the first upper layer communication unit, and the second processing unit and the physical layer communication unit are connected via the second upper layer communication unit.

According to such an aspect, the in-vehicle device includes a plurality of processing units composed of a first processing unit and a second processing unit, and as one example, such processing units (that is, the first processing unit and the second processing unit) are composed of microcomputers or the like. The in-vehicle device includes a physical layer communication unit, such as a Control Area Network (CAN) transceiver or an Ethernet (registered trademark) PHY unit, and is connected to an in-vehicle network, such as a CAN bus or an Ethernet cable, via this physical layer communication unit. The first processing unit (a first microcomputer) and the second processing unit (a second microcomputer) each include an upper layer communication unit corresponding to a layer that is higher than the physical layer communication unit, with such upper layer communication units being composed of CAN controllers, for example. That is, the first processing unit includes a first upper layer communication unit (a CAN controller), and the second processing unit includes a second upper layer communication unit (also a CAN controller). When the in-vehicle device is connected to the in-vehicle network via the physical layer communication unit, the second upper layer communication unit of the second processing unit is connected to the physical layer communication unit, and the first upper layer communication unit of the first processing unit is connected to the second processing unit. By doing so, the physical layer communication unit, the second processing unit (specifically the second upper layer communication unit), and the first processing unit (specifically the first upper layer communication unit) become connected in series in this order to the in-vehicle network. Accordingly, since the first processing unit is connected to the physical layer communication unit and the in-vehicle network via the second processing unit, the second processing unit can take charge of processing that outputs communication data, which has been outputted from the first processing unit, via the physical layer communication unit to the in-vehicle network. By distributing the processing load relating to communication control, such as CAN control, to the second processing unit (that is, having such processing concentrated at the second processing unit), the communication-related processing can be performed efficiently. At the first processing unit, the processing load related to communication control, such as CAN control, can be reduced, which means that the first processing unit can be prevented from becoming occupied by communication control. In addition, the first processing unit can efficiently execute logical computational processing relating to vehicle control itself, such as processing that conforms to AUTOSAR (that is, the first processing unit can realize logical functions as an in-vehicle device).

In an in-vehicle device according to an aspect of the present disclosure, a processing performance of the first processing unit is higher than a processing performance of the second processing unit.

According to such an aspect, since the processing performance of the first processing unit is higher than the processing performance of the second processing unit, which is directly connected to the physical layer communication unit, the first processing unit, which has a comparatively high processing capacity and a high cost, can be effectively utilized by having the first processing unit execute logical computational processing relating to vehicle control itself, such as processing that conforms to AUTOSAR. The second processing unit, which has comparatively low processing performance and a low cost, can be effectively utilized by having the second processing unit perform communication control, such as CAN control, which needs real-time response but is mostly I/O control. By dividing the processing to be handled (executed) by the first processing unit, which has high processing performance and a high cost, and the second processing unit, which has low processing power and a low cost, according to the type of computational processing, it becomes possible to efficiently perform both logical computational processing relating to vehicle control and the like and processing relating to communication control, such as CAN control.

In an in-vehicle device according to an aspect of the present disclosure, the first processing unit executes a plurality of programs relating to control of the vehicle, and the second processing unit executes processing relating to selection of communication data to be outputted to the in-vehicle network, out of communication data generated by the first processing unit executing a program.

According to such an aspect, the first processing unit generates communication data by executing a plurality of programs relating to control of a vehicle and outputs the generated communication data to the second processing unit. Since the second processing unit executes processing relating to the selection of communication data to be outputted to the in-vehicle network via the physical layer communication unit out of the communication data outputted from the first processing unit, it is possible to prevent unnecessary communication data (such as CAN messages) from being outputted (transmitted) from the in-vehicle device to the in-vehicle network. By doing so, it is possible to suppress an increase in traffic (the usage of communication bandwidth) on the in-vehicle network.

In an in-vehicle device according to an aspect of the present disclosure, the first processing unit is provided with a plurality of first upper layer communication units, and the plurality of first upper layer communication units are connected to a bus connection circuit included in the second processing unit.

According to such an aspect, the first processing unit includes a plurality of first upper layer communication units, and the second processing unit includes a bus connection circuit to which each of the plurality of first upper layer communication units is connected. By doing so, the first processing unit and the second processing unit are connected by a plurality of paths provided by the plurality of first upper layer communication units, which makes it possible to provide redundancy in the communication paths between the first processing unit and the second processing unit and to increase the communication bandwidth, which makes it easier to maintain communication quality. The plurality of first upper layer communication units in the first processing unit are connected to a bus connection circuit included in the second processing unit, and the bus connection circuit constructs a closed network (an in-vehicle internal CAN bus) inside the in-vehicle device. By doing so, communication between programs (applications), that is, inter-process communication, which is performed only inside the in-vehicle device can be performed via the bus connection circuit (an in-vehicle internal CAN bus), which makes it possible to efficiently perform communication inside the in-vehicle device without being affected by the communication state on the in-vehicle network which is outside the in-vehicle device.

In an in-vehicle device according to an aspect of the present disclosure, the first processing unit executes a plurality of programs with different safety levels defined by ASIL, and the plurality of first upper layer communication units are classified according to safety levels of the programs.

According to such an aspect, the first processing unit executes a plurality of programs with different safety levels defined by ASIL (Automotive Safety Integrity Level), and communication data outputted by executing such programs are each outputted to the second processing unit via one out of the plurality of first upper layer communication units. This plurality of first upper layer communication units are classified according to the safety levels of the programs and are set so as to be assigned differently depending on the safety levels of programs. That is, the plurality of first upper layer communication units include a first upper layer communication unit (a high-level first upper layer communication unit) to which communication data from a program with a comparatively high safety level is assigned and a first upper layer communication unit (a low-level first upper layer communication unit) to which communication data from a program with a comparatively low safety level is assigned. In this way, by classifying (that is, assigning communication data to) the plurality of first upper layer communication units according to the safety levels of programs in this way, it is possible to lessen the influence that communication by a program with a low safety level has on communication by a program with a high safety level.

In an in-vehicle device according to an aspect of the present disclosure, the second processing unit includes a filter unit that filters the communication data outputted via the bus connection circuit from the first processing unit, and the filter unit is interposed between the bus connection circuit and the second upper layer communication unit.

According to such an aspect, the second processing unit includes a filter unit, which is interposed between the bus connection circuit and the second upper layer communication unit. The second processing unit uses the filter unit to filter the communication data outputted from the first processing unit via the bus connection circuit. By doing so, it is possible for the in-vehicle device to efficiently execute processing relating to the selection of communication data to be outputted to the in-vehicle network out of the communication data that has been generated and outputted by the first processing unit executing programs.

In an in-vehicle device according to the present disclosure, the second processing unit acquires a control signal outputted from the first processing unit and performs filtering by the filter unit in accordance with the acquired control signal.

According to such an aspect, when filtering is performed on communication data outputted from the first processing unit, the second processing unit controls the filter unit to perform the filtering in keeping with a control signal outputted from the first processing unit. By performing filtering in keeping with the control signal, it is possible to efficiently select, out of the communication data outputted from the first processing unit, communication data that is to be outputted via the physical layer communication unit to the in-vehicle network and communication data that is not to be outputted.

In an in-vehicle device according to an aspect of the present disclosure, each of the first processing unit and the second processing unit includes a control signal interface for transmitting and receiving the control signal.

According to such an aspect, the control signal generation unit included in the first processing unit generates a control signal, which indicates whether communication data is to be subjected to filtering, based on the communication data received by the first upper layer communication unit, and outputs the generated control signal to the control interface of the second processing unit. The control signal generating unit of the first processing unit and the control interface of the second processing unit function as control signal interfaces when control signals and the like are transmitted and received such functional sites. Since a control signal for performing processing related to filtering is transmitted and received via the respective control signal interfaces of the first processing unit and the second processing unit (that is, the control signal generating unit of the first processing unit and the control interface of the second processing unit), it is possible to prevent the first upper layer communication unit and the bus connection circuit through which communication data, such as CAN messages, flows from being affected by control signals.

A program according to an aspect of the present disclosure causes a computer to execute a process, the computer being connected to an in-vehicle network installed in a vehicle and including: a first processing unit; a second processing unit connected to the first processing unit; and a physical layer communication unit connected to the second processing unit, wherein the first processing unit includes a first upper layer communication unit corresponding to a layer that is higher than the physical layer communication unit, the second processing unit includes a second upper layer communication unit corresponding to a layer that is higher than the physical layer communication unit, the first processing unit and the second processing unit are connected via the first upper layer communication unit, and the second processing unit and the physical layer communication unit are connected via the second upper layer communication unit, the process including: causing the first processing unit to execute a plurality of programs relating to control of the vehicle, and outputting, via the first upper layer communication unit, communication data generated by execution of the programs to the second processing unit; and causing the second processing unit to receive the communication data outputted from the first processing unit and selecting communication data to be outputted to the in-vehicle network out of the received communication data.

According to such an aspect, it is possible to provide a program that causes a computer to function as an in-vehicle device that efficiently performs processing related to communication.

An information processing method according to an aspect of the present disclosure causes a computer to execute a process, the computer being connected to an in-vehicle network installed in a vehicle and including: a first processing unit; a second processing unit connected to the first processing unit; and a physical layer communication unit connected to the second processing unit, wherein the first processing unit includes a first upper layer communication unit corresponding to a layer that is higher than the physical layer communication unit, the second processing unit includes a second upper layer communication unit corresponding to a layer that is higher than the physical layer communication unit, the first processing unit and the second processing unit are connected via the first upper layer communication unit, and the second processing unit and the physical layer communication unit are connected via the second upper layer communication unit, the process including: causing the first processing unit to execute a plurality of programs relating to control of the vehicle, and outputting, via the first upper layer communication unit, communication data generated by execution of the programs to the second processing unit; and causing the second processing unit to receive the communication data outputted from the first processing unit and selecting communication data to be outputted to the in-vehicle network out of the received communication data.

According to such an aspect, it is possible to provide an information processing method that causes a computer to function as an in-vehicle device that efficiently performs processing related to communication.

Preferred embodiments of the present disclosure will now be described with reference to the drawings. A in-vehicle device 1 according to an embodiment of the present disclosure is described below with reference to the drawings. Note that the present disclosure is not limited to the embodiments given here, is indicated by the range of the patent claims, and is intended to include all possible changes and modifications within the meaning and scope of the patent claims and their equivalents.

### First Embodiment

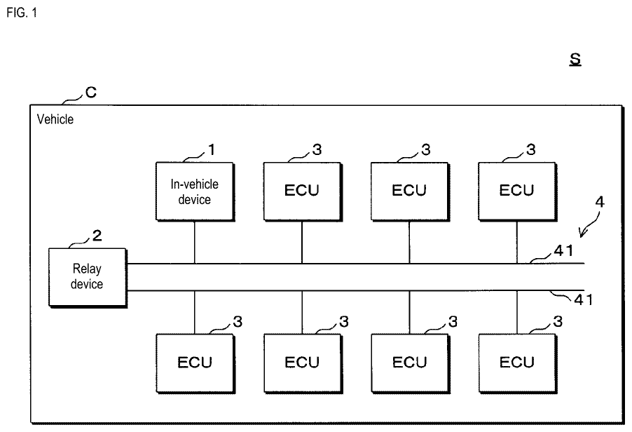

An embodiment of the present disclosure is described below with reference to the drawings. FIG. 1 is a schematic diagram depicting an example system configuration of an in-vehicle system S according to a first embodiment. The in-vehicle system S includes an in-vehicle device 1, in-vehicle ECUs 3, a relay device 2 that connects the in-vehicle device 1 and the in-vehicle ECUs 3 to enable communication between them, and an in-vehicle network 4, all of which are mounted in a vehicle C.

The in-vehicle device 1 may be an integrated ECU that performs integrated control of the vehicle C as a whole. Alternatively, the in-vehicle device 1 may be configured as a body ECU or the like that controls body-related actuators in the vehicle C. The in-vehicle device 1 may be connected to in-vehicle devices, such as sensors and actuators. This in-vehicle device 1 will be described in detail later.

Each in-vehicle ECU 3 includes a processing unit, a storage unit, an input/output interface, an in-vehicle communication unit, and the like, and may be connected to an in-vehicle device, such as a sensor or an actuator. The in-vehicle ECUs 3 perform processing related to the control of such in-vehicle devices. The in-vehicle ECUs 3 may be individual ECUs that are connected under the control of the in-vehicle device 1 that functions as an integrated ECU.

The relay device 2 is composed of a CAN gateway or an Ethernet switch, for example. A plurality of communication lines 41, such as a CAN bus or an Ethernet cable, are connected to the relay device 2, and the relay device 2 relays communication data transmitted and received between the in-vehicle ECUs 3 connected to the respective communication lines 41 and between the in-vehicle device 1 and the in-vehicle ECUs 3. The in-vehicle network 4 is composed of the plurality of communication lines 41 connected to the relay device 2. The in-vehicle device 1, the in-vehicle ECUs 3, and the like are connected to each other via the in-vehicle network 4 to enable communication between them.

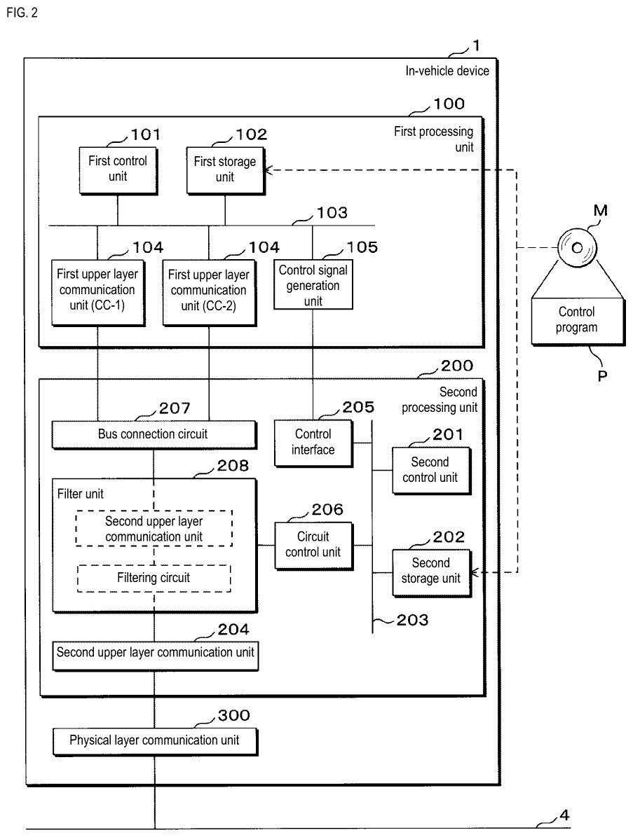

FIG. 2 is a block diagram depicting an example internal configuration of the in-vehicle device 1 included in the in-vehicle system S. The in-vehicle device 1 includes a first processing unit 100, a second processing unit 200, and a physical layer communication unit 300. The first processing unit 100, the second processing unit 200, and the physical layer communication unit 300 are connected to each other by an internal bus or inter-board wiring, for example. When the in-vehicle device 1 is connected to the in-vehicle network 4, the physical layer communication unit 300, the second processing unit 200, and the first processing unit 100 are connected in series in this order from the in-vehicle network 4 side.

The first processing unit 100 (the first microcomputer) may be composed of a microcomputer or the like that has higher processing performance than the second processing unit 200 (the second microcomputer). The first processing unit 100 (the first microcomputer) and the second processing unit 200 (the second microcomputer”) may be composed of a single chip or a plurality of chips. When a single-chip configuration is used, the in-vehicle device 1 may be constructed of a chip with an eFPGA configuration where a microcomputer (the first processing unit 100) and an FPGA (the second processing unit 200) are integrated. In this way, the in-vehicle device 1 may be configured as a heterogeneous multiprocessor system.

The first processing unit 100 (the first microcomputer) is composed of a microcomputer, for example, and efficiently executes logical computational processing relating to vehicle C control itself, such as processing that conforms to AUTOSAR (that is, the first processing unit 100 realizes the logic functions of the in-vehicle device 1). The first processing unit 100 includes a first control unit 101, a first storage unit 102, a first internal bus 103, a first upper layer communication unit 104, and a control signal generation unit 105. The first control unit 101, the first storage unit 102, the first upper layer communication unit 104, and the control signal generation unit 105 are connected via the first internal bus 103 to enable communication between them.

The first control unit 101 is composed of a CPU (Central Processing Unit), an MPU (Micro Processing Unit) or the like and performs various control processing and computational processing by reading and executing a control program P (a program product) and data stored in advance in the first storage unit 102. As examples, the control unit includes a single-core single CPU, a single-core multi-CPU, a multi-core single CPU, and a multi-core multi-CPU.

The control program P may include a plurality of programs (applications) with different safety levels as defined by ASIL (Automotive Safety Integrity Level). The first control unit 101 executes this plurality of programs (applications) using a pipeline parallel configuration or the like to perform logical computational processing relating to the vehicle C control itself, such as processing that conforms to AUTOSAR. The first control unit 101 outputs communication data generated by executing this plurality of programs (applications) via the first internal bus 103 to the first upper layer communication unit 104.

The first storage unit 102 is composed of a volatile memory element, such as RAM (Random Access Memory), or a nonvolatile memory element, such as a ROM (Read Only Memory), an EEPROM (Electrically Erasable Programmable ROM) or flash memory, or a combination of such storage devices, and stores the control program P (the program product) and data to be referenced during processing in advance. The control program P (program product) stored in the first storage unit 102 may be a control program P (program product) that was read from a recording medium M that is readable by the in-vehicle device 1. Alternatively, the control program P (program product) may be a program that was downloaded from an external computer (not illustrated) connected to a communication network (also not illustrated) and then stored in the first storage unit 102. A communication control table, described later, may also be stored in the first storage unit 102.

As one example, the first internal bus 103 is composed of lands, conductive patterns, and the like formed on a board on which the first control unit 101 and the like are mounted, or on a microcomputer board that constructs the first processing unit 100. The first control unit 101, the first storage unit 102, the first upper layer communication unit 104, and the control signal generation unit 105 are connected via this first internal bus 103 to enable communication between them.

As one example, the first upper layer communication unit 104 is a communication unit corresponding to a data link layer, which is a higher layer than a physical layer, such as a CAN controller or an Ethernet controller. In the present embodiment, the first processing unit 100 may be equipped with two or more first upper layer communication units 104. The plurality of first upper layer communication units 104 may be classified according to the respective safety levels of the programs (applications) executed by the first control unit 101. This classification, that is, the assignment of a suitable first upper layer communication unit 104 to each program (application) may be defined in a communication control table, described later.

The control signal generation unit 105 may be a hardware processing unit constructed of a computational circuit, such as an ASIC (Application Specific Integrated Circuit) or an FPGA (Field Programmable Gate Array). Alternatively, the control signal generation unit 105 may be a software processing unit constructed of an MPU or the like in the same way as the first control unit 101. The control signal generation unit 105 acquires, monitors, or samples, via the first internal bus 103, communication data generated and outputted by the first control unit 101 executing a program. The control signal generation unit 105 reads a communication control table stored for example in the first storage unit 102, determines whether filtering of the communication data outputted from the first control unit 101 is required, and outputs a control signal (a control request) to a control interface 205 of the second processing unit 200 in keeping with this determination result. As examples, this control signal may be SPI, I2C, UART, or GPIO that are used on or between the boards on which the first processing unit 100 and the second processing unit 200 are mounted. The control signal generation unit 105 functions as a control signal interface when transmitting and receiving control signals and the like.

The second processing unit 200 (the second microcomputer) is composed of a microcomputer or the like, for example, mainly executes communication control such as CAN control, and executes processing relating to the selection of communication data to be outputted from the in-vehicle device 1 to the in-vehicle network 4. The second processing unit 200 includes a second control unit 201, a second storage unit 202, a second internal bus 203, a second upper layer communication unit 204, the control interface 205, a circuit control unit 206, a bus connection circuit 207, and a filter unit 208.

The second control unit 201, the second storage unit 202, the control interface 205, and the circuit control unit 206 are connected via the second internal bus 203 to enable communication between them. The circuit control unit 206 and the filter unit 208 are connected by an internal bus to enable communication between them. The bus connection circuit 207, the filter unit 208, and the second upper layer communication unit 204 are connected in series in this order by an internal bus to enable communication between them. The bus connection circuit 207 is connected to each of the plurality of first upper layer communication units 104 included in the first processing unit 100 via an internal bus to enable communication. The second upper layer communication unit 204 is connected to the physical layer communication unit 300 via an internal bus to enable communication between them. Accordingly, in the direction of flow of communication data transmitted from the first processing unit 100 to the second processing unit 200, functional components composed of a first upper layer communication unit 104 of the first processing unit 100, the bus connection circuit 207, the filter unit 208, and the second upper layer communication unit 204 of the second processing unit 200, and the physical layer communication unit 300 are connected in series in that stated order. By doing so, a communication circuit is formed that extends from the first processing unit 100 via the second processing unit 200 to the physical layer communication unit 300.

The second control unit 201 is constructed of a CPU or the like in the same way as the first control unit 101, and performs various control processing, computational processing, and the like by reading and executing the control program P (program product) and data stored in advance in the second storage unit 202. The second control unit 201 may be constructed as a simple processor with lower processing performance than the first control unit 101. Alternatively, the second control unit 201 may be composed of an FPGA or the like. The second control unit 201 acquires a control signal (or control request) outputted from the first processing unit 100 (specifically, the control signal generation unit 105) via the control interface 205, performs processing such as interpretation of the acquired control signal, and performs processing for controlling the circuit control unit 206. The second control unit 201 may generate a signal to control the circuit control unit 206 in response to a control signal (a control request) from the first processing unit 100 (specifically, the control signal generation unit 105) and output the generated signal to the circuit control unit 206.

The second storage unit 202 is composed of a RAM or ROM in the same way as the first storage unit 102 and stores in advance the control program P (the program product) and data to be referenced during processing. The storage capacity of the second storage unit 202 may be smaller than the storage capacity of the first storage unit 102. By doing so, the component cost of the second processing unit 200 can be reduced.

As one example, the second internal bus 203 is composed of lands, conductive patterns, and the like formed on a board on which the second control unit 201 and the like are mounted, or on a microcomputer board that constructs the second processing unit 200. The second control unit 201, the second storage unit 202, the control interface 205, and the circuit control unit 206 are connected via the second internal bus 203 to enable communication between them.

The control interface 205 is an interface that receives a control signal (a control request) from the control signal generation unit 105 of the first processing unit 100 and functions as a control signal interface for when control signals and the like are transmitted and received. The control interface 205 may transmit a control signal (a control request) that has been received to the second control unit 201 via the second storage unit 202, which is composed of a RAM or the like, or by using a means such as a control register.

The circuit control unit 206 is a functional site that uses a means such as a register to provide an interface to communication circuits, including the filter unit 208 and the like. The circuit control unit 206 performs control such as activating filtering processing by the filter unit 208 in keeping with control by the second control unit 201.

As one example, the bus connection circuit 207 is composed of an electrical circuit provided on a board on which the second control unit 201 and the like are mounted, or on a microcomputer board that constructs the second processing unit 200. Alternatively, the bus connection circuit 207 may be constructed (realized) as a logic circuit using programmable logic, such as an FPGA. The bus connection circuit 207 is connected to the first upper layer communication units 104 of the first processing unit 100 and the filter unit 208 of the second processing unit 200 to function as a network inside the in-vehicle device 1, such as a CAN bus inside the in-vehicle device 1.

The filter unit 208 is a functional site that performs filtering processing in accordance with control by the circuit control unit 206. The filter unit 208 may include a communication unit, which corresponds to a data link layer such as CAN controller, and a filtering circuit and the like. The communication unit corresponding to the data link layer may have a similar configuration to the second upper layer communication unit 204 and may be connected to the bus connection circuit 207. This communication unit included in the filter unit 208 may control CAN communication and the like on the board on which the first processing unit 100 and the second processing unit 200 are mounted.

The filter unit 208 (a filtering circuit) may be set to perform a transmission process where, in a steady state, that is, in a state where no control is being performed by the circuit control unit 206, communication data outputted from the bus connection circuit 207 is outputted to the second upper layer communication unit 204 without being filtered. Alternatively, the filter unit 208 may switch between performing and not performing filtering depending on the type of control signal (a control request) outputted from the first processing unit 100 (that is, according to whether the outputted control signal is a “filtering required control signal” or a “no filtering control signal”).

Like the first upper layer communication unit 104, the second upper layer communication unit 204 is a communication unit corresponding to a data link layer, which is a higher layer than the physical layer, such as a CAN controller or an Ethernet controller. The second upper layer communication unit 204 is interposed between the filter unit 208 and the physical layer communication unit 300. The second upper layer communication unit 204 may control CAN communication and the like outside the board on which the first processing unit 100 and the second processing unit 200 are mounted, that is, communication transmitted and received to and from the in-vehicle device 1 on the in-vehicle network 4.

As one example, the physical layer communication unit 300 is constructed of with a CAN transceiver that is compatible with CAN or CAN-FD, or an Ethernet PHY unit compatible with Ethernet, and is a communication unit that is compatible with the communication lines 41 (the physical layer), which may be CAN buses or Ethernet cables. The in-vehicle device 1 is connected via this physical layer communication unit 300 to the in-vehicle network 4 and is connected to the in-vehicle ECUs 3 connected to the in-vehicle network 4 to enable communication between them. The physical layer communication unit 300 composed of a CAN transceiver or the like may have a plurality of channels.

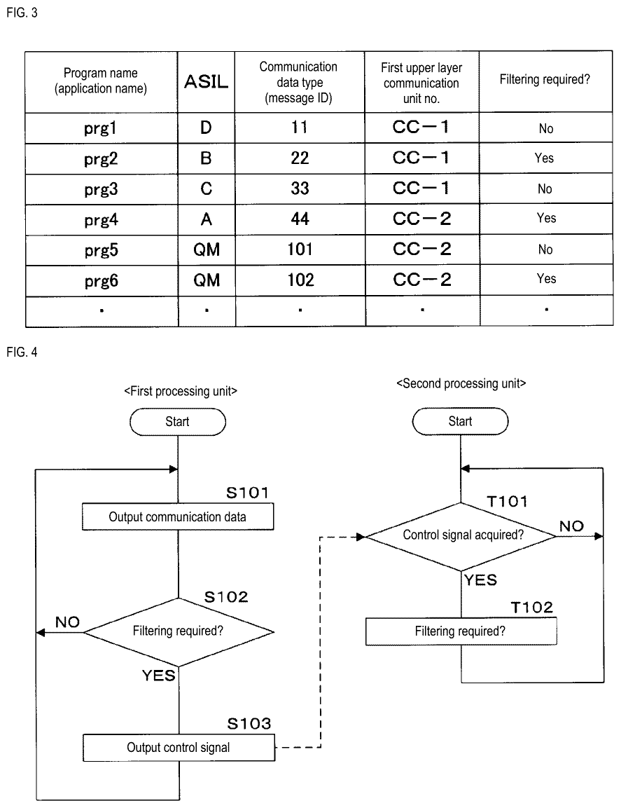

FIG. 3 is a diagram useful in explaining one example of a communication control table. As one example, the communication control table is stored in the first storage unit 102 of the first processing unit 100 (the first microcomputer). The first control unit 101 and the control signal generation unit 105 included in the first processing unit 100 (the first microcomputer) may perform various processing by referring to this communication control table. Examples of management items (fields) defined in the communication control table include “program name”, “ASIL”, “communication data type”, “first upper layer communication unit No.”, and “filtering required?”.

The “program name” management field stores the names (executable file names) of programs (applications) executed by the first control unit 101. The “ASIL” management field stores ASIL (Automotive Safety Integrity Level) values that define the safety levels of the corresponding programs (applications).

The “communication data type” management field stores values indicating the type of communication data outputted by executing the corresponding programs (applications). As examples, the values indicating the type of communication data may be a message ID (CAN-ID) for CAN communication or a TCP port number for TCP/IP communication.

The “first upper layer communication unit No.” management field stores the device number or the like of the first upper layer communication unit 104 which is assigned in keeping with the safety level of the corresponding program (application). In the present embodiment, the first processing unit 100 includes two first upper layer communication units 104 (“CC-1” and “CC-2”). In this case, the first upper layer communication unit 104 (CC-1) is assigned a program (application) with a higher safety level than the first upper layer communication unit 104 (CC-2).

The management field of “whether the filtering is required?” defines whether the communication data outputted by executing the corresponding program (application) is to be subjected to filtering by the second processing unit 200 (specifically, the filter unit 208), or in other words, whether filtering is required. Communication data (that is, the communication data type) that is defined as “filtering required” corresponds to internal communication data that is not to be outputted to the in-vehicle network 4. Communication data (that is, the communication data type) that is defined as “no filtering” corresponds to external communication data that is to be outputted to the in-vehicle network 4. In this way, by defining whether filtering is required based on the type of communication data or the name of a program (application), it is possible to efficiently execute processing relating to the selection of communication data to be outputted from the in-vehicle device 1 to the in-vehicle network 4.

FIG. 4 is a flowchart indicating the processing of the first processing unit 100 and the second processing unit 200 provided in the in-vehicle device 1. Although the processing by the first processing unit 100 and the second processing unit 200 are related to each other, the processing by the first processing unit 100 will be described first and then the processing by the second processing unit 200 will be described.

The first processing unit 100 outputs communication data (S101). The first control unit 101 of the first processing unit 100 executes a plurality of programs (applications) in parallel and executes logical computational processing relating to the vehicle C control itself, such as processing that conforms to AUTOSAR, using pipeline parallelism or the like. By executing these programs, the first control unit 101 of the first processing unit 100 generates communication data.

The first control unit 101 of the first processing unit 100 outputs the generated communication data via the first internal bus 103 to the first upper layer communication unit 104 that has been assigned (classified) in keeping with the safety level (ASIL: Automotive Safety Integrity Level) defined for each of the programs. The first control unit 101 of the first processing unit 100 may identify the first upper layer communication unit 104 that has been assigned in keeping with the safety level defined for each of the programs by referring to the communication control table stored in the first storage unit 102.

The communication data outputted to each of the first upper layer communication units 104, which are classified according to the safety levels of programs, is outputted to the bus connection circuit 207 of the second processing unit 200. By doing so, communication is performed between the first processing unit 100 and the second processing unit 200. In addition, communication (inter-process communication) is performed between the plurality of first upper layer communication units 104 connected to the bus connection circuit 207 of the second processing unit 200 via the bus connection circuit 207.

Each of the plurality of first upper layer communication units 104 is classified according to the safety level of the corresponding programs, and by transmitting and receiving communication data between these plurality of first upper layer communication units 104 via the bus connection circuit 207, communication (inter-process communication) is performed between a plurality of programs that are executed in parallel at the first control unit 101. By doing so, the bus connection circuit 207 of the second processing unit 200 can be made to function as a network inside the in-vehicle device 1 (that is, an internal CAN bus of the in-vehicle device 1).

The first processing unit 100 determines whether filtering is required for the outputted communication data (S102). The control signal generation unit 105 of the first processing unit 100 acquires, monitors, or samples, via the first internal bus 103, communication data that has been generated and outputted by the first control unit 101 executing a program on its own or in cooperation with the first processing unit 100 and determines whether filtering by the bus connection circuit 207 is required.

When determining whether filtering is required, the control signal generation unit 105 of the first processing unit 100 may identify the communication data type of the communication data outputted from the first processing unit 100. The control signal generation unit 105 of the first processing unit 100 may determine whether filtering is required or unnecessary for the identified communication data type as one example by referring to the communication control table stored in the first storage unit 102.

When it has been determined that filtering is required (S102: YES), the first processing unit 100 outputs a control signal to the second processing unit 200 to execute filtering (S103). When the control signal generation unit 105 of the first processing unit 100 has determined that filtering is required for the communication data outputted from the first processing unit 100, the control signal generation unit 105 generates a control signal (a control request) for causing the second processing unit 200 to perform filtering and outputs the generated control signal (the control request) to the control interface 205 of the second processing unit 200. The second control unit 201 of the second processing unit 200 acquires the control signal (the control request) outputted via the control interface 205 from the control signal generation unit 105 of the first processing unit 100.

After executing S103, or if it has been determined that filtering is unnecessary (S102: NO), the first processing unit 100 performs loop processing to execute the processing from S101 again. If it has been determined that filtering is unnecessary, the first processing unit 100 may output a control signal indicating that filtering is not required, that is, a control signal for transmission processing of the communication data.

The second processing unit 200 determines whether a control signal for executing filtering has been acquired from the first processing unit 100 (T101). The second control unit 201 of the second processing unit 200 continuously performs processing to wait for a control signal (a control request) outputted via the control interface 205 from the control signal generation unit 105 of the first processing unit 100 and determines whether a control signal has been acquired from the control interface 205. The control interface 205 may transfer the control signal (the control request) to the second control unit 201 using the second storage unit 202, which may be a control register or a RAM.

If it has been determined that a control signal has been acquired (T101: YES), the second processing unit 200 executes filtering on the communication data outputted from the first processing unit 100 (T102). If it has been determined that a control signal (that is, a control signal for executing filtering) has been acquired, the second control unit 201 of the second processing unit 200 executes processing, such as interpreting the control signal, and controls the circuit control unit 206.

The circuit control unit 206 controlled by the second control unit 201 activates the filtering function of the filter unit 208 to filter the communication data outputted from the first processing unit 100. By doing so, the communication data outputted from the first processing unit 100 to the second processing unit 200 is discarded without being outputted to the physical layer communication unit 300, which makes it possible to prevent the communication data from being outputted from the in-vehicle device 1 to the in-vehicle network 4.

If it has been determined that a control signal has not been acquired (T101: NO), the second processing unit 200 does not filter the communication data outputted from the first processing unit 100. In a steady state, that is, a state where no control signal has been inputted, the filter unit 208 is set to perform a transmission process in which communication data outputted from the bus connection circuit 207 is outputted to the second upper layer communication unit 204 without being filtered. Accordingly, the communication data outputted from the first processing unit 100 to the second processing unit 200 is outputted from the second processing unit 200 to the physical layer communication unit 300 without being filtered by the second processing unit 200 and is outputted via the physical layer communication unit 300 to the in-vehicle network 4. Note that the second processing unit 200 may not filter the communication data outputted from the first processing unit 100 when the second processing unit 200 has received a control signal from the first processing unit 100 indicating that filtering is not required (that is, a control signal for transmission processing of the communication data). After executing T101, or when it has been determined that a control signal has not been acquired (T101: NO), the second processing unit 200 performs loop processing to execute T101 again.

When the filter unit 208 switches between performing filtering and not performing filtering in keeping with the type of control signal (a control request) outputted from the first processing unit 100, the second control unit 201 may control the circuit control unit 206 and the filter unit 208 in keeping with the type of control signal. That is, when the control signal from the first processing unit 100 is a control signal (a filtering required control signal) for executing filtering, the second control unit 201 may control the circuit control unit 206 to perform a filtering process by the filter unit 208. When the control signal from the first processing unit 100 is a control signal (a no filtering control signal) indicating that filtering is not required, the second control unit 201 may control the circuit control unit 206 to not execute the filtering process by the filter unit 208 and to perform the transmission process on the communication data.

When processing such as CAN communication is performed by a plurality of applications (software), it is assumed that a communication unit realized by a CAN controller, a CAN transceiver, or the like is shared or commonly used by such plurality of applications. While it would be conceivable for a specific application (or representative software) to control the communication unit on behalf of other applications, in such case, there is concern that the processing of the representative software would produce a concentrated load (CPU processing load) at the control unit or that the CPU cores that construct the control unit would become entirely occupied by such processing.

On the other hand, in a configuration where the in-vehicle device 1 is composed of a plurality of processing units (microcomputers), namely the first processing unit 100 (the first microcomputer) and the second processing unit 200 (the second microcomputer), when applications (software) to be executed are assigned according to the processing performance of each of these processing units, communication control such as CAN control will be assigned to the processing unit with comparatively low processing performance (that is, the second processing unit 200).

This makes it possible to prevent the processing unit with high processing performance (that is, the first processing unit 100) from being occupied by communication control, which improves the processing efficiency for programs. It is also possible to suppress increases in the number of communication units, such as CAN controllers, installed in the in-vehicle device 1, and thereby suppress increases in component costs and product weight due to the addition of such hardware. Communication between a plurality of applications is performed inside the in-vehicle device 1, and it is possible to prevent unnecessary communication data (such as CAN messages) from being outputted (transmitted) from the in-vehicle device 1 to the in-vehicle network 4. In addition, it is possible to eliminate software-based processing, such as simulation of CAN signals and proxy transmission. By using the filter unit 208, it is possible to select only required communication data (signals) and send such data to a communication line 41 (the in-vehicle network 4) such as a CAN bus, which makes it possible to reduce the amount of communication on the in-vehicle network 4.

All features of the embodiments disclosed here are exemplary and should not be regarded as limitations on the present disclosure. The scope of the present disclosure is indicated by the range of the patent claims, not the description given above, and is intended to include all changes within the meaning and scope of the patent claims and their equivalents.

A plurality of claims listed in the range of the patent claims can also be combined with each other regardless of how the claims depend on each other. The range of the patent claims include multiple dependent claims that depend on a plurality of other claims. Although the range of the patent claims as written does not include multiple dependent claims that depend on other multiple dependent claims, multiple dependent claims that depend on other multiple dependent claims may also be included.

1. An in-vehicle device to be connected to an in-vehicle network installed in a vehicle, the in-vehicle device comprising:
a first processing unit;
a second processing unit connected to the first processing unit; and
a physical layer communication unit connected to the second processing unit,
wherein the first processing unit includes a first upper layer communication unit corresponding to a layer that is higher than the physical layer communication unit,
the second processing unit includes a second upper layer communication unit corresponding to a layer that is higher than the physical layer communication unit,
the first processing unit and the second processing unit are connected via the first upper layer communication unit, and
the second processing unit and the physical layer communication unit are connected via the second upper layer communication unit.

2. The in-vehicle device according to claim 1,
wherein a processing performance of the first processing unit is higher than a processing performance of the second processing unit.

3. The in-vehicle device according to claim 2,
wherein the first processing unit executes a plurality of programs relating to control of the vehicle, and
the second processing unit executes processing relating to selection of communication data to be outputted to the in-vehicle network, out of communication data generated by the first processing unit executing a program.

4. The in-vehicle device according to claim 1,
wherein the first processing unit is provided with a plurality of first upper layer communication units, and
the plurality of first upper layer communication units are connected to a bus connection circuit included in the second processing unit.

5. The in-vehicle device according to claim 4,
wherein the first processing unit executes a plurality of programs with different safety levels defined by ASIL, and
the plurality of first upper layer communication units are classified according to safety levels of the programs.

6. The in-vehicle device according to claim 4,
wherein the second processing unit includes a filter unit that filters the communication data outputted via the bus connection circuit from the first processing unit, and
the filter unit is interposed between the bus connection circuit and the second upper layer communication unit.

7. The in-vehicle device according to claim 6,
wherein the second processing unit acquires a control signal outputted from the first processing unit and performs filtering by the filter unit in accordance with the acquired control signal.

8. The in-vehicle device according to claim 7,
wherein each of the first processing unit and the second processing unit includes a control signal interface for transmitting and receiving the control signal.

9. A program that causes a computer to execute a process, the computer being connected to an in-vehicle network installed in a vehicle and including:
a first processing unit;
a second processing unit connected to the first processing unit; and
a physical layer communication unit connected to the second processing unit,
wherein the first processing unit includes a first upper layer communication unit corresponding to a layer that is higher than the physical layer communication unit,
the second processing unit includes a second upper layer communication unit corresponding to a layer that is higher than the physical layer communication unit,
the first processing unit and the second processing unit are connected via the first upper layer communication unit, and
the second processing unit and the physical layer communication unit are connected via the second upper layer communication unit,
the process comprising:
causing the first processing unit to execute a plurality of programs relating to control of the vehicle, and outputting, via the first upper layer communication unit, communication data generated by execution of the programs to the second processing unit; and
causing the second processing unit to receive the communication data outputted from the first processing unit and selecting communication data to be outputted to the in-vehicle network out of the received communication data.

10. An information processing method that causes a computer to execute a process, the computer being connected to an in-vehicle network installed in a vehicle and including:
a first processing unit;
a second processing unit connected to the first processing unit; and
a physical layer communication unit connected to the second processing unit,
wherein the first processing unit includes a first upper layer communication unit corresponding to a layer that is higher than the physical layer communication unit,
the second processing unit includes a second upper layer communication unit corresponding to a layer that is higher than the physical layer communication unit,
the first processing unit and the second processing unit are connected via the first upper layer communication unit, and
the second processing unit and the physical layer communication unit are connected via the second upper layer communication unit,
the process comprising:
causing the first processing unit to execute a plurality of programs relating to control of the vehicle, and outputting, via the first upper layer communication unit, communication data generated by execution of the programs to the second processing unit; and
causing the second processing unit to receive the communication data outputted from the first processing unit and selecting communication data to be outputted to the in-vehicle network out of the received communication data.

11. The in-vehicle device according to claim 5,
wherein the second processing unit includes a filter unit that filters the communication data outputted via the bus connection circuit from the first processing unit, and
the filter unit is interposed between the bus connection circuit and the second upper layer communication unit.
